(19) United States
(12) Patent Application Publication
(10) Pub. No.: US 2026/0074104 A1
(43) Pub. Date: Mar. 12, 2026

(54) MAGNETIC COMPONENT

(71) Applicant: Delta Electronics, Inc., Taoyuan City (TW)

(72) Inventors: Han-Hsing Lin, Taoyuan City (TW); Chia-Ming Liu, Taoyuan City (TW); Chun-Kai Mao, Taoyuan City (TW); Chun-Ping Chen, Taoyuan City (TW); Yi-Jia Chen, Taoyuan City (TW)

(21) Appl. No.: 18/961,385

(22) Filed: Nov. 26, 2024

(30) Foreign Application Priority Data
Sep. 12, 2024 (CN) 202411278604.2

(51) Int. Cl. H01F 27/22; H01F 27/24; H01F 27/29; H01F 27/32

(52) U.S. Cl. CPC H01F 27/22; H01F 27/24; H01F 27/29; H01F 27/325

(57) ABSTRACT

The present invention provides a magnetic component. The magnetic component includes a magnetic core, at least one winding and at least one insulating and thermal-conducting element. The at least one winding is wound around the magnetic core. The at least one insulating and thermal-conducting element is configured to at least partially encapsulate or be attached and coupled to at least one of the magnetic core and the winding. The insulating and thermal-conducting element is served as a thermal bus path for transferring the heat generated by the magnetic core and/or the winding.

### CROSS-REFERENCE TO RELATED APPLICATION

This application claims priority to China Patent Application No. 202411278604.2 filed on Sep. 12, 2024, the entire content of which is incorporated herein by reference for all purposes.

### FIELD OF THE INVENTION

The present disclosure relates to an electronic component, and more particularly to a magnetic component.

### BACKGROUND OF THE INVENTION

Magnetic components have been widely used in various technological fields, such as 5G communication equipment and automotive electronic devices. Since the magnetic components have significant influences on the efficiency of the above-mentioned equipment or devices, the magnetic components with better heat dissipation performance can notably enhance the efficiency of the above-mentioned equipment or devices.

On the other hand, to comply with waterproof and dustproof standards like IP65, cooling of the magnetic components in related equipment or devices is primarily achieved through passive cooling methods. To enhance thermal conductivity, thermal pads are often used to dispose between the magnetic components and the heat sinks, so that the heat generated by the magnetic components is transferred through the thermal pads to the heat sinks and then dissipated into the environment. However, in the current manufacturing process, the process of attaching one side of the thermal pad to the magnetic component needs to be carried out manually and cannot be achieved in an automated manner. Consequently, the production time is long. Additionally, the manually attaching process is prone to tolerances. When the other side of the thermal pad is attached to the heat sink during subsequent process, a gap is easily formed between the thermal pad and the heat sink, which results in poor thermal conductivity. Furthermore, due to the shape limitations of the magnetic component and the thermal pad, it is difficult to encapsulate or tightly attach the thermal pad to the surface of the magnetic component. Consequently, the heat generated by the magnetic component cannot be transferred effectively.

Moreover, taking an inductor as an example of the magnetic component, the assembly of the inductor is usually achieved by adhesive dispensing and fixation method or epoxy potting method. In the adhesive dispensing and fixation method, the glue is employed to dispense between the magnetic core and the base, wherein at least one coil is wound around the magnetic core. Consequently, the magnetic core and the base are fixed with each other. In this adhesive dispensing and fixation method, the size of the gap between each magnetic core and the base to be assembled, as well as the amount of adhesive dispensed in each adhesive dispensing process, will be different. Therefore, after the adhering process of the magnetic component is achieved, a gap is easily formed between the magnetic core and the base, which results in poor thermal conductivity of the magnetic component. In addition, the commonly used materials for the base and the adhesive have poor thermal conductivity, which seriously affects the heat dissipation efficiency of the magnetic components. On the other hand, the epoxy potting method requires manual glue filling and baking processes, which results in a larger dimensional error of the finished product and makes it difficult to control the dimensional accuracy of the finished product.

Therefore, there is a need of providing an improved magnetic component to obviate the drawbacks encountered from the prior arts.

### SUMMARY OF THE INVENTION

It is an object of the present disclosure to provide a magnetic component that utilizes an insulating and thermal-conducting element to at least partially encapsulate or be adhered and coupled to at least one of the magnetic core and the winding, thereby forming a thermal bus path for transferring the heat generated by the magnetic core and/or the winding. Additionally, the insulating and thermal-conducting element can also be used as a base or a molded component for the magnetic component, which can not only enhance the thermal conductivity, improve the heat dissipation efficiency, increase the fixation strength and reduce the volume but also integrate the elements in the magnetic component, reduce the manufacturing time and cost, and achieve waterproof and dustproof effects. Moreover, the finished product of the present disclosure is directly formed by the material with high thermal conductivity through the molding technique. The dimensional errors caused by manual positioning in conventional methods can be avoided. Besides, the dimensional accuracy can be improved and controlled within plus or minus 0.2 mm, which is unachievable by conventional methods.

In accordance with an aspect of the present disclosure, there is provided a magnetic component including a magnetic core, at least one winding, and at least one insulating and thermal-conducting element. The at least one winding is wound around the magnetic core. The insulating and thermal-conducting element is configured to encapsulate or attach and couple to at least one of the magnetic core and the winding. The insulating and thermal-conducting element is served as a thermal bus path for transferring the heat generated by the magnetic core and/or the winding.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A is a schematic perspective view illustrating a magnetic component according to a first embodiment of the present disclosure;

FIG. 1B is a schematic perspective view illustrating a magnetic core of the magnetic component according to the first embodiment of the present disclosure;

FIG. 1C is a schematic perspective view illustrating a metal plate of the magnetic component embedded in an insulating and thermal-conducting element according to the first embodiment of the present disclosure;

FIG. 2A is a schematic perspective view illustrating a magnetic component according to a second embodiment of the present disclosure;

FIG. 2B is a schematic perspective view illustrating the magnetic component according to a second embodiment of the present disclosure connected to a circuit board and a thermal pad;

FIG. 3A is a partial exploded view illustrating a magnetic component according to a third embodiment of the present disclosure;

FIG. 3B is a partial exploded view illustrating the magnetic component according to the third embodiment of the present disclosure from another viewpoint;

FIG. 3C is a schematic perspective view illustrating a first insulating and thermal-conducting element and a second insulating and thermal-conducting element of the magnetic component according to the third embodiment of the present disclosure;

FIG. 3D is a schematic perspective view illustrating a magnetic core of the magnetic component according to the third embodiment of the present disclosure;

FIG. 4A is an exploded view illustrating a magnetic component according to a fourth embodiment of the present disclosure;

FIG. 4B is a schematic perspective view illustrating the magnetic component according to the fourth embodiment of the present disclosure;

FIG. 5A is an exploded view illustrating a magnetic component according to a fifth embodiment of the present disclosure;

FIG. 5B is a schematic perspective view illustrating the magnetic component according to the fifth embodiment of the present disclosure;

FIG. 6A is an exploded view illustrating a magnetic component according to a sixth embodiment of the present disclosure; and

FIG. 6B is a schematic perspective view illustrating the magnetic component according to the sixth embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “upper,” “lower,” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items. Alternatively, the word “about” means within an acceptable standard error of ordinary skill in the art-recognized average. In addition to the operation/working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present invention and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

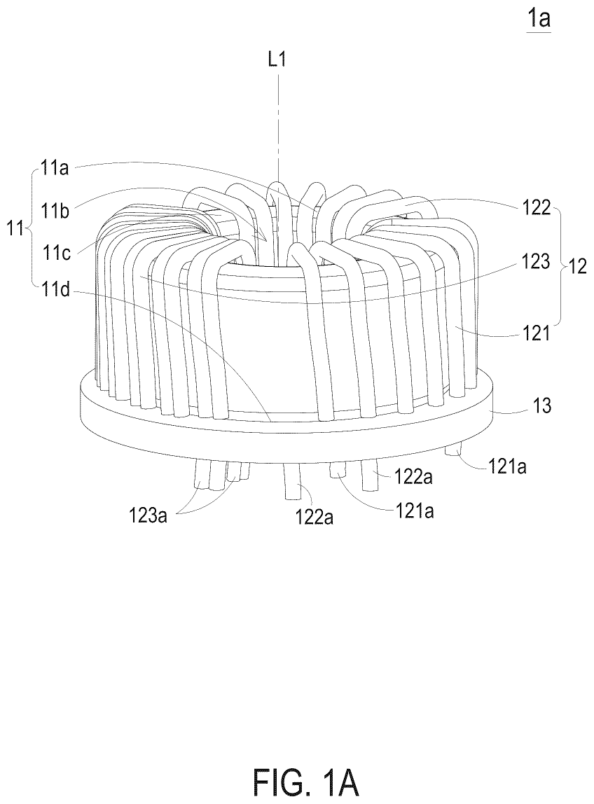

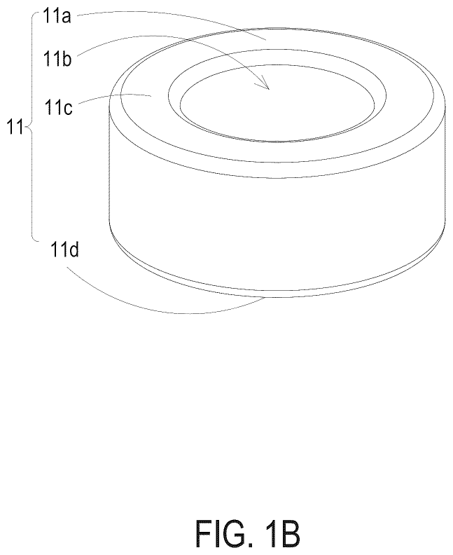

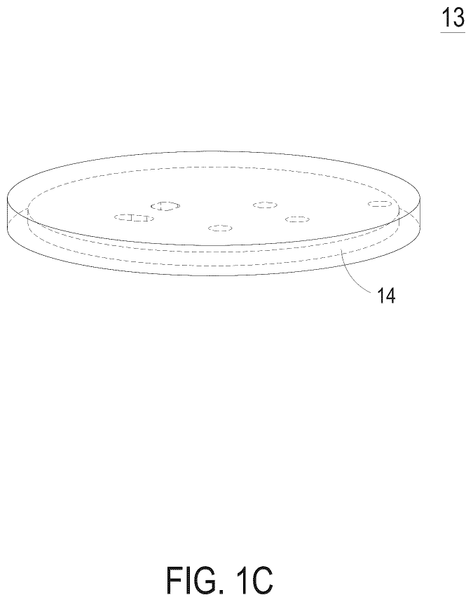

FIG. 1A is a schematic perspective view illustrating a magnetic component according to a first embodiment of the present disclosure. FIG. 1B is a schematic perspective view illustrating a magnetic core of the magnetic component according to the first embodiment of the present disclosure. FIG. 1C is a schematic perspective view illustrating a metal plate of the magnetic component embedded in an insulating and thermal-conducting element according to the first embodiment of the present disclosure. As shown in FIGS. 1A, 1B and 1C, the magnetic component 1a is but not limited to an inductor or a choke. The magnetic component 1a includes a magnetic core 11, at least one winding 12 and an insulating and thermal-conducting element 13. The magnetic core 11 includes a magnetic ring 11a, a hollow portion 11b, a top surface 11c and a bottom surface 11d. The magnetic ring 11a has an axis L1. The hollow portion 11b penetrates the center of the magnetic core 11 so that the magnetic ring 11a is defined. The top surface 11c and the bottom surface 11d are two opposite surfaces of the magnetic core 11. Each winding 12 passes through the hollow portion 11b of the magnetic core 11 and is wound around the magnetic ring 11a. Preferably, the insulating and thermal-conducting element 13 is in a plate shape. The insulating and thermal-conducting element 13 is configured to at least partially encapsulate or attach and couple to at least one of the magnetic core 11 and the winding 12, and is served as a thermal bus path for transferring the heat generated by the magnetic core 11 and/or the winding 12. The insulating and thermal-conducting element 13 also can be served as a base or a molded component for the magnetic component 1a. Consequently, the thermal conductivity is enhanced, the heat dissipation efficiency is improved, the fixation strength is increased, the volume is reduced, the elements in the magnetic component are integrated, the manufacturing time and cost is reduced, and the waterproof and dustproof effects are achieved. Preferably but not exclusively, the axis L1 of the magnetic ring 11a is perpendicular to the insulating and thermal-conducting element 13.

In an embodiment, the number of the winding 12 is three, i.e., the first winding 121, the second winding 122 and the third winding 123. In addition, the type of the winding 12 can be single-wired or double-wired, e.g., the first winding 121 and the second winding 122 are single-wired winding, respectively, and the third winding 123 is double-wired winding. It is noted that the number and the type of the winding 12 are not limited to the above embodiment and can be adjusted according to the practical requirements. For example, in other embodiments, the number of the winding 12 can be one or two, and the type of the winding 12 can be flat-wired. In an embodiment, the first winding 121 includes two terminal ends 121a, the second winding 122 includes two terminal ends 122a, and the third winding 123 includes two terminal ends 123a. The terminal ends 121a, 122a, 123a are protruded from the bottom surface 11d of the magnetic core 11, and the terminal ends 121a, 122a, 123a penetrate through and are positioned in the insulating and thermal-conducting element 13. Each of the terminal ends 121a, 122a, 123a is protruded from the bottom surface of the insulating and thermal-conducting element 13 to be served as a pin for connecting to a corresponding via hole on the circuit board (not shown) in subsequent applications.

In this embodiment, the insulating and thermal-conducting element 13 is formed on the bottom surface 11d of magnetic core 11 by an insert molding process. The insulating and thermal-conducting element 13 encapsulates or is attached and coupled to the bottom surface 11d of the magnetic core 11 and encapsulates portion of the winding 12. Preferably but not exclusively, the insulating and thermal-conducting element 13 is made of a bulk molding compound BMC having higher thermal conductivity coefficient by insert molding process. The insulating and thermal-conducting element 13 has a specific thermal conductivity coefficient and a characteristic of electrical insulation. Preferably, the specific thermal conductivity coefficient is ranged between 1.5 W/m·k and 3.2 W/m k. More preferably, the specific thermal conductivity coefficient is ranged between 2.0 W/m·k and 2.9 W/m·k. In some embodiments, the bulk molding compound with higher thermal conductivity coefficient is but not limited to a high thermal conductivity and pressure resistant plastic. It is noted that the material constitutes the insulating and thermal-conducting element 13 is not limited to the above embodiment and can be adjusted according to the practical requirements. As mentioned above, the insulating and thermal-conducting element 13 encapsulates or is attached and coupled to the bottom surface 11d of the magnetic core 11 and encapsulates portion of the winding 12, and the insulating and thermal-conducting element 13 has a higher thermal conductivity coefficient. Since the insulating and thermal-conducting element 13 has lower thermal resistance, the insulating and thermal-conducting element 13 is served as a thermal bus path. Therefore, the heat generated by the magnetic core 11 and winding 12 can be dissipated away from the magnetic component 1a through the thermal bus path. Namely, the heat generated by the magnetic core 11 and winding 12 can be dissipated away from the system through the insulating and thermal-conducting element 13. It is noted that the area and the range that the insulating and thermal-conducting element 13 encapsulates or is attached and coupled to the magnetic core 11 and the winding 12 are not limited to the above embodiment and can be adjusted according to the practical requirements. For example, in some embodiments, the insulating and thermal-conducting element 13 encapsulates the magnetic core 11 entirely and encapsulates most part of the winding 12 with only a small part of the winding 12 exposed from the insulating and thermal-conducting element 13 to be served as a pin. Besides, since the insulating and thermal-conducting element 13 positions the terminal ends of the winding 12 directly for allowing the terminal ends to be served as pins after its formation, there is no need to make holes on a base at first for the terminal ends 121a, 122a, 123a of the winding 12 to pass through as in the prior arts. Consequently, the structure of the magnetic component 1a is simplified and the assembly time and costs are reduced.

In an embodiment, as shown in FIG. 1B, the magnetic component 1a further includes a metal plate 14 embedded in the insulating and thermal-conducting element 13. Preferably but not exclusively, the metal plate 14 is an aluminum plate or a copper plate. The metal plate 14 has a plurality of through holes for the terminal ends of the corresponding winding 12 to pass therethrough. By disposing the metal plate 14 in the insulating and thermal-conducting element 13, the temperature uniformity and the equivalent thermal conductivity of the insulating and thermal-conducting element 13 are increased to further reduce the thermal resistance of the thermal bus path. Consequently, the efficiency of dissipating the heat away from the magnetic component 1a is improved.

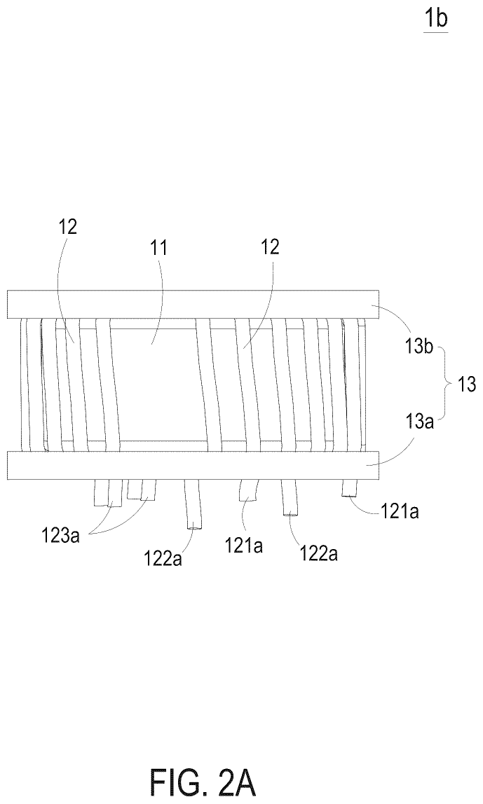

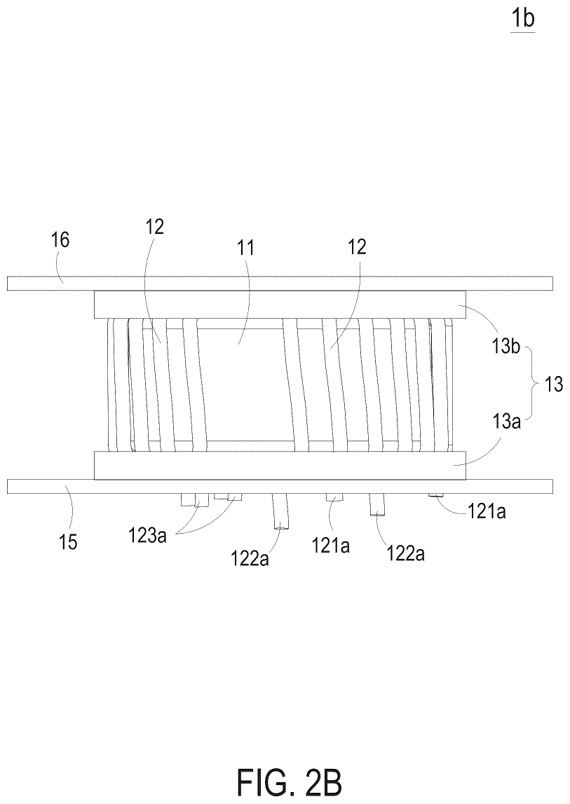

FIG. 2A is a schematic perspective view illustrating a magnetic component according to a second embodiment of the present disclosure. FIG. 2B is a schematic perspective view illustrating the magnetic component according to a second embodiment of the present disclosure connected to a circuit board and a thermal pad. As shown in FIGS. 2A and 2B, in this embodiment, the structures of the magnetic core 11 of the magnetic component 1b and the winding 12 are the same as that of the first embodiment and are not redundantly described hereinafter. In this embodiment, differing from the magnetic component 1a of the first embodiment, the magnetic component 1b includes two insulating and thermal-conducting elements 13 such as a first insulating and thermal-conducting element 13a and a second insulating and thermal-conducting element 13b. Both the first insulating and thermal-conducting element 13a and the second insulating and thermal-conducting element 13b have a plate structure. The first insulating and thermal-conducting element 13a encapsulates or is attached and coupled to the bottom surface 11d of the magnetic core 11 and portion of the winding 12. The second insulating and thermal-conducting element 13b encapsulates or is attached and coupled to the top surface 11c of the magnetic core 11 and portion of the winding 12. In this embodiment, the material and the forming method of the first insulating and thermal-conducting element 13a and the second insulating and thermal-conducting element 13b are similar to that of the first embodiment and are not redundantly described hereinafter. In some embodiments, the terminal ends 121a, 122a, 123a of the magnetic component 1b passes through the corresponding via holes of the circuit board 15 and are connected to the circuit board 15. The first insulating and thermal-conducting element 13a of the magnetic component 1b is attached and coupled to the circuit board 15. The second insulating and thermal-conducting element 13b of the magnetic component 1b is attached and coupled to a thermal pad 16. Since the first insulating and thermal-conducting element 13a and the second insulating and thermal-conducting element 13b have higher thermal conductivity coefficients, the first insulating and thermal-conducting element 13a and the second insulating and thermal-conducting element 13b can respectively be served as a thermal bus path. Consequently, the heat generated by the magnetic core 11 and the winding 12 is dissipated away from the magnetic component 1b though the thermal bus paths. Namely, the heat generated by the magnetic core 11 and winding 12 is transferred to the circuit board 15 through the first insulating and thermal-conducting element 13a and then dissipated away from the system through the circuit board 15, and the heat generated by the magnetic core 11 and winding 12 is transferred to the thermal pad 16 through the second insulating and thermal-conducting element 13b and then dissipated away from the system through the thermal pad 16 or a heat sink (not shown) further attached on the thermal pad 16.

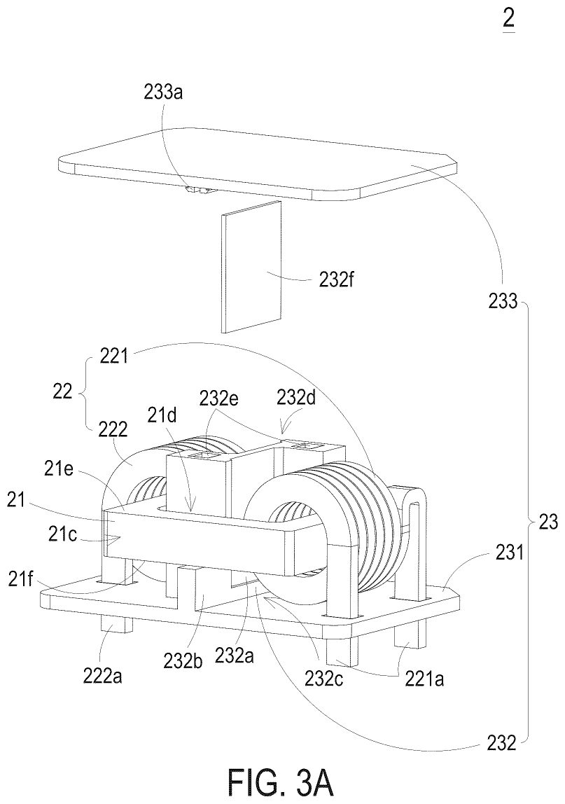

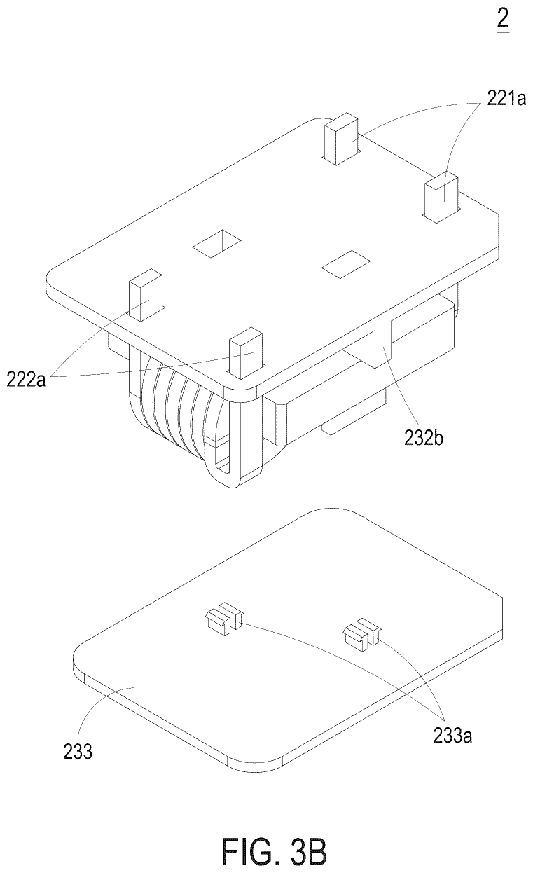

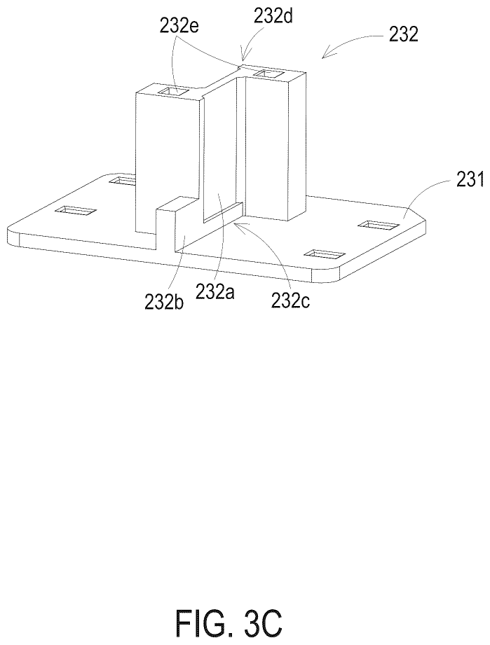

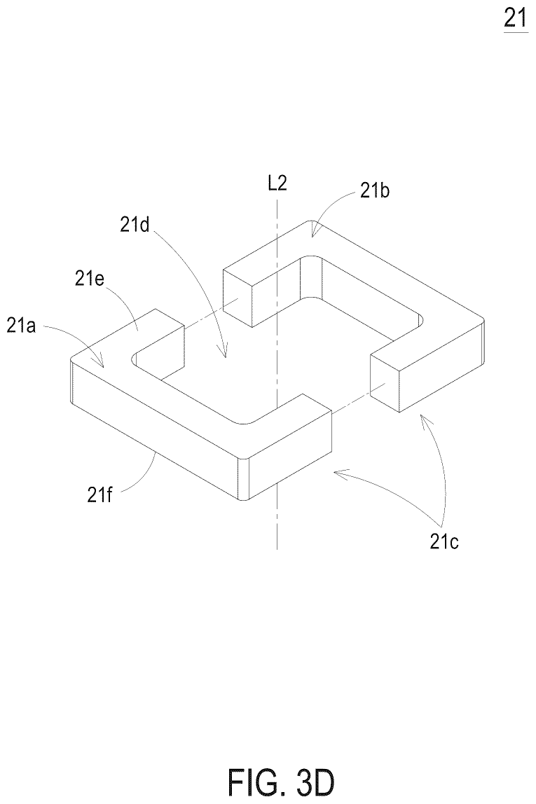

FIG. 3A is a partial exploded view illustrating a magnetic component according to a third embodiment of the present disclosure. FIG. 3B is a partial exploded view illustrating the magnetic component according to the third embodiment of the present disclosure from another viewpoint. FIG. 3C is a schematic perspective view illustrating a first insulating and thermal-conducting element and a second insulating and thermal-conducting element of the magnetic component according to the third embodiment of the present disclosure. FIG. 3D is a schematic perspective view illustrating a magnetic core of the magnetic component according to the third embodiment of the present disclosure. As shown in FIGS. 3A, 3B, 3C and 3D, the magnetic component 2 is but not limited to a transformer. The magnetic component 2 include a magnetic core 21, at least one winding 22 and at least one insulating and thermal-conducting element 23. In this embodiment, the magnetic core 21 includes a first magnetic core part 21a, a second magnetic core part 21b, a hollow portion 21d, a top surface 21e and a bottom surface 21f. The first magnetic core part 21a and the second magnetic core part 21b are coupled to each other so that a magnetic frame 21c is defined. Preferably but not exclusively, the first magnetic core part 21a and the second magnetic core part 21b can be UU type magnetic cores, UI type magnetic cores or EE type magnetic cores. The hollow portion 21d is in the center area of the magnetic core 21 and penetrates the magnetic frame 21c. The magnetic frame 21c has an axis L2. The top surface 21e and the bottom surface 21f are two opposite surfaces of the magnetic core 21. In this embodiment, the winding 22 includes a first winding 221 and a second winding 222 respectively served as a primary winding and a secondary winding of the transformer. In an embodiment, the type of the winding 22 is but not limited to flat-wired. It is noted that the number and the type of the winding 22 are not limited to the above embodiment and can be adjusted according to the practical requirements. Each winding 22 passes through the hollow portion 21d of the magnetic core 21 and is wound on the magnetic frame 21c. The first winding 221 includes two terminal ends 221a and the second winding 222 includes two terminal ends 222a. Each of the terminal ends 221a, 222a is protruded from the bottom surface 21f of the magnetic core 21. Each of the terminal ends 221a, 222a penetrates through and is positioned in the insulating and thermal-conducting element 23. Each of the terminal ends 221a, 222a is protruded from the bottom surface of the insulating and thermal-conducting element 23 to be served as a pin for connecting to a corresponding via hole on the circuit board (not shown) in subsequent applications.

In this embodiment, the at least one insulating and thermal-conducting element 23 includes a first insulating and thermal-conducting element 231 and a second insulating and thermal-conducting element 232. The first insulating and thermal-conducting element 231 has a plate structure. The second insulating and thermal-conducting element 232 includes a main body 232a and two extension parts 232b. The two extension parts 232b are respectively extended from two outer surfaces of the two lateral sides at the bottom of the main body 232a and are connected to the first insulating and thermal-conducting element 231. The first insulating and thermal-conducting element 231 and the second insulating and thermal-conducting element 232 are arranged perpendicularly to each other. The first insulating and thermal-conducting element 231 encapsulates portion of the winding 22. A first end 232c of the second insulating and thermal-conducting element 232 is coupled to the first insulating and thermal-conducting element 231. The second insulating and thermal-conducting element 232 is disposed in the hollow portion 21d of the magnetic core 21 and located between the first winding 221 and the second winding 222. In an embodiment, the two extension parts 232b of the second insulating and thermal-conducting element 232 are attached and coupled to the bottom surface 21f of the magnetic core 21. The area and the range that the second insulating and thermal-conducting element 232 encapsulates or is attached and coupled to the magnetic core 21 are not limited to the above embodiment and can be adjusted according to the practical requirements. In an embodiment, the top surfaces of the two extension parts 232b and the outer surfaces of two lateral sides of the main body 232a of the second insulating and thermal-conducting element 232 are respectively attached and coupled to the bottom surface 21f and the inner surface of the magnetic core 21. Consequently, the heat generated by the winding 22 and the magnetic core 21 is dissipated away from the magnetic component 2 through a thermal bus path formed by the first insulating and thermal-conducting element 231 and the second insulating and thermal-conducting element 232. In an embodiment, preferably but not exclusively, the axis L2 of the magnetic frame 21c is perpendicular to the first insulating and thermal-conducting element 231.

In this embodiment, the magnetic component 2 further includes a third insulating and thermal-conducting element 233. Preferably but not exclusively, the third insulating and thermal-conducting element 233 has a plate structure. A second end 232d of the second insulating and thermal-conducting element 232 is coupled to the third insulating and thermal-conducting element 233. The second insulating and thermal-conducting element 232 and the third insulating and thermal-conducting element 233 are arranged perpendicularly to each other. Preferably but not exclusively, the first insulating and thermal-conducting element 231 and the second insulating and thermal-conducting element 232 are integrally formed in one piece. Namely, the first insulating and thermal-conducting element 231 and the second insulating and thermal-conducting element 232 are formed by insert molding process at the same time. In this embodiment, the second end 232d of the second insulating and thermal-conducting element 232 includes at least one slot 232e, and the third insulating and thermal-conducting element 233 includes at least one buckle 233a. The second insulating and thermal-conducting element 232 and the third insulating and thermal-conducting element 233 are coupled to each other by engaging the slot 232e and the buckle 233a. Alternatively, the second end 232d of the second insulating and thermal-conducting element 232 includes at least one buckle, and the third insulating and thermal-conducting element 233 includes at least one slot. The second insulating and thermal-conducting element 232 and the third insulating and thermal-conducting element 233 are coupled to each other by engaging the slot and the buckle. In some embodiments, the second insulating and thermal-conducting element 232 and the third insulating and thermal-conducting element 233 are integrally formed in one piece, or the first insulating and thermal-conducting element 231, the second insulating and thermal-conducting element 232 and the third insulating and thermal-conducting element 233 are integrally formed in one piece. In an embodiment, the third insulating and thermal-conducting element 233 is not in contact with the winding 22, but is not limited thereto. In some embodiments, the third insulating and thermal-conducting element 233 is attached and coupled to or at least partially encapsulate the winding 22. Consequently, the heat generated by the winding 22 and the magnetic core 21 is dissipated away from the magnetic component 2 through the thermal bus path formed by the first insulating and thermal-conducting element 231, the second insulating and thermal-conducting element 232 and the third insulating and thermal-conducting element 233. In addition, the insulating and thermal-conducting element 23 is served as a base for the magnetic component 2. Consequently, the thermal conductivity is enhanced, the heat dissipation efficiency is improved, the fixation strength is increased, the volume is reduced, the elements in the magnetic component are integrated, the manufacturing time and cost are reduced, and the waterproof and dustproof effects are achieved.

In some embodiments, the magnetic component 2 includes a metal plate 232f or a magnetic plate, embedded in the second insulating and thermal-conducting element 232. Preferably but not exclusively, the metal plate 232f is an aluminum plate or a copper plate, and the magnetic plate is made of a material the same as that of the magnetic core 21. The second insulating and thermal-conducting element 232 is located between the first winding 221 and the second winding 222, which makes the encapsulated metal plate 232f or the magnetic plate positioned between the first winding 221 and the second winding 222. The temperature uniformity and the equivalent thermal conductivity of the second insulating and thermal-conducting element 232 are increased by utilizing the metal plate 232f so as to improve the efficiency of dissipating heat away from the magnetic component 2, and the leakage inductance of the magnetic component 2 is increased or adjusted by utilizing the magnetic plate. In some embodiments, the magnetic component 2 includes a plurality of metal plates respectively embedded in the first insulating and thermal-conducting element 231, the second insulating and thermal-conducting element 232, and/or the third insulating and thermal-conducting element 233. Consequently, the temperature uniformity and the equivalent thermal conductivity of the insulating and thermal-conducting element 23 are increased to improve the efficiency of dissipating heat away from the magnetic component 2.

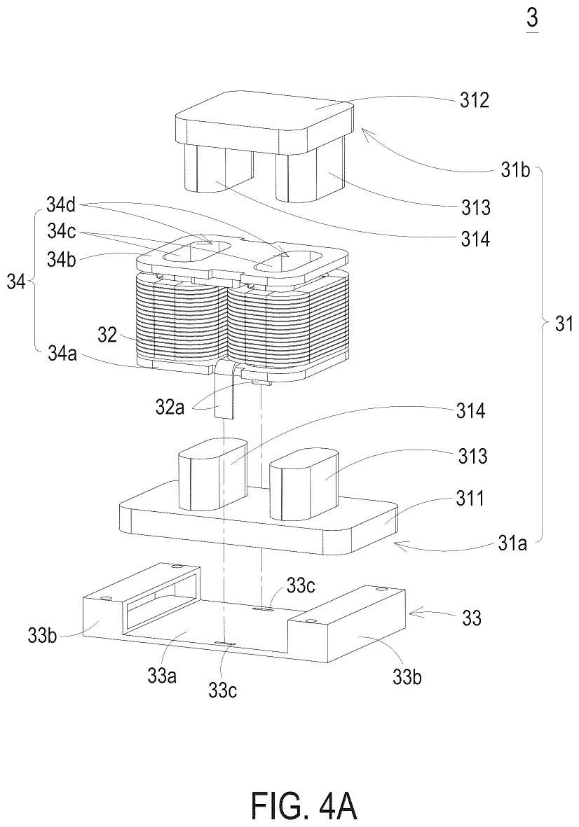

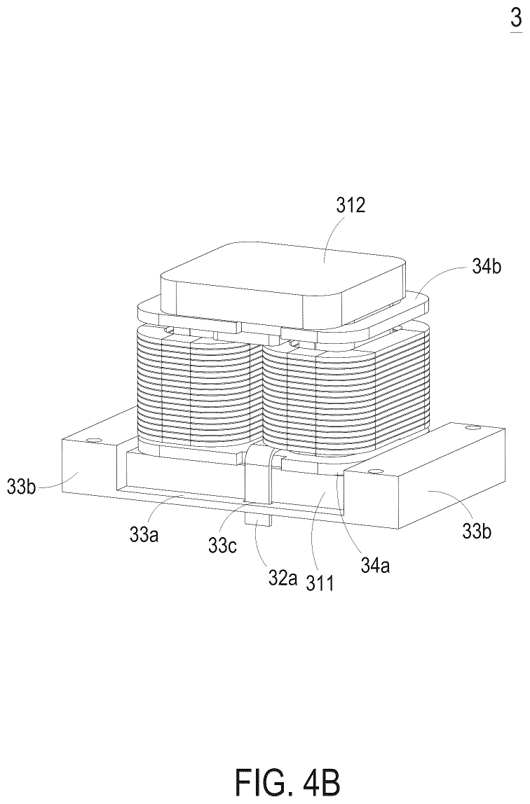

FIG. 4A is an exploded view illustrating a magnetic component according to a fourth embodiment of the present disclosure. FIG. 4B is a schematic perspective view illustrating the magnetic component according to the fourth embodiment of the present disclosure. As shown in FIGS. 4A and 4B, the magnetic component 3 is but not limited to an inductor or a choke. The magnetic component 3 includes a magnetic core 31, at least one winding 32, at least one insulating and thermal-conducting element 33 and a bobbin 34. The magnetic core 31 includes a first magnetic core part 31a and a second magnetic core part 31b. The first magnetic core part 31a and the second magnetic core part 31b are coupled to each other and includes a first magnetic plate 311, a second magnetic plate 312, a first lateral leg 313 and a second lateral leg 314. Two ends of each of the first lateral leg 313 and the second lateral leg 314 are respectively connected to the first magnetic plate 311 and the second magnetic plate 312. The first lateral leg 313 and the second lateral leg 314 are separated from and parallel to each other. In this embodiment or other embodiments, the first magnetic core part 31a and the second magnetic core part 31b can be UU type magnetic cores or UI type magnetic cores, but is not limited thereto. The bobbin 34 includes a bottom plate 34a, a top plate 34b, two winding tubes 34c and two passages 34d. The bobbin 34 is integrally formed in one piece. Two ends of each winding tube 34c are respectively connected to the bottom plate 34a and the top plate 34b, and the two winding tubes 34c are separated from and parallel to each other. The two passages 34d respectively penetrate the bottom plate 34a, the top plate 34b and the corresponding winding tube 34c. In this embodiment, the number of the winding 32 is one, and the winding 32 forms two winding portions respectively wound around two winding areas located at the outer peripheral edges of the two winding tubes 34c. The winding 32 includes two terminal ends 32a, and the two terminal ends 32a extend downward along the periphery of the bottom plate 34a of the bobbin 34. In other embodiments, the magnetic component 3 includes a plurality of the windings 32, and each of the windings 32 respectively forms a winding part and each winding part is disposed on the corresponding winding tube 34c in the winding area of the winding tube 34c. In this embodiment, the first lateral leg 313 and the second lateral leg 314 of the magnetic core 31 respectively penetrate and are positioned in the corresponding passages 34d of the two winding tubes 34c. The insulating and thermal-conducting element 33 includes a bottom piece 33a, two side walls 33b and two perforations 33c. The two side walls 33b are respectively connected to two lateral sides of the top surface of the bottom piece 33a and are protruded from the bottom piece 33a. The top surface of the bottom piece 33a is attached and coupled to the bottom surface of the first magnetic plate 311. In this embodiment, the length between the two side walls 33b is slightly greater than the length of the first magnetic plate 311, so that the two side walls 33b encapsulate the first magnetic plate 311, and the two side walls 33b are attached and coupled to the two lateral surfaces and the top surface of the first magnetic plate 311 when the insulating and thermal-conducting element 33 is formed. The length between the two side walls 33b is not limited, in some embodiments, the length between the two side walls 33b is the same as the length of the first magnetic plate 311, so that the two side walls 33b are attached and coupled to the two lateral surfaces of the first magnetic plate 311.

The perforations 33c penetrate the bottom piece 33a and are corresponding in position to the two terminal ends 32a of the winding 32 for the two terminal ends 32a of the winding 32 to pass therethrough and protrude from the bottom surface of the bottom piece 33a to be served as pins. Besides, two terminal ends 32a of the winding 32 are partially encapsulated by the insulating and thermal-conducting element 33 and fixed on the insulating and thermal-conducting element 33. Consequently, by the arrangement of the insulating and thermal-conducting element 33, a thermal bus path is formed and the heat generated by the magnetic core 31 and the winding 32 is dissipated away through the thermal bus path. At the same time, the two terminal ends 32a of the winding 32 are fixed and served as pins. In addition, the insulating and thermal-conducting element 33 is served as a base for the magnetic component 3. Consequently, the thermal conductivity is enhanced, the heat dissipation efficiency is improved, the fixation strength is increased, the volume is reduced, the elements in the magnetic component are integrated, the manufacturing time and cost are reduced, and the waterproof and dustproof effects are achieved.

In this embodiment, the magnetic component 3 further includes a metal plate (not shown) embedded in the bottom piece 33a of the insulating and thermal-conducting element 33. Preferably but not exclusively, the metal plate (now shown) is an aluminum plate or a copper plate. By arranging the metal plate, the temperature uniformity and the equivalent thermal conductivity of the insulating and thermal-conducting element 33 are increased to further improve the efficiency of dissipating the heat away from the magnetic component 3.

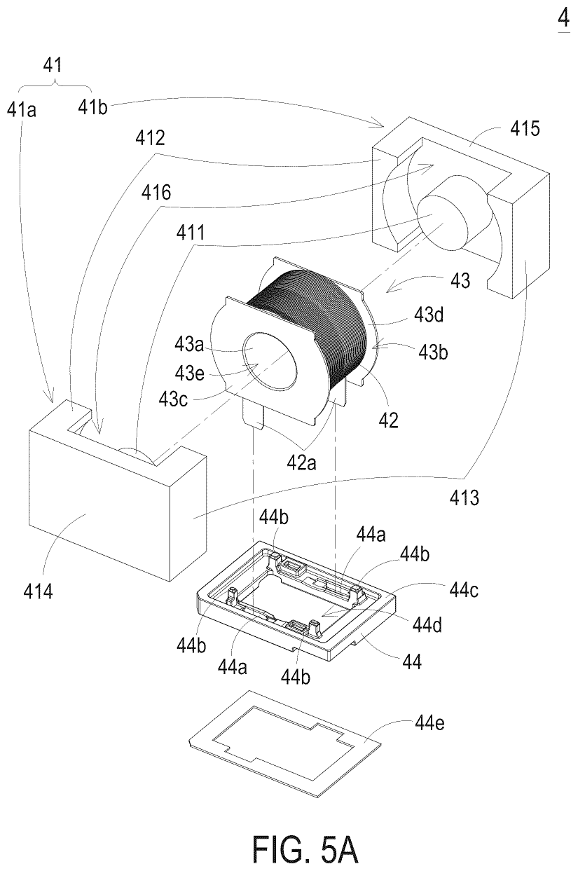

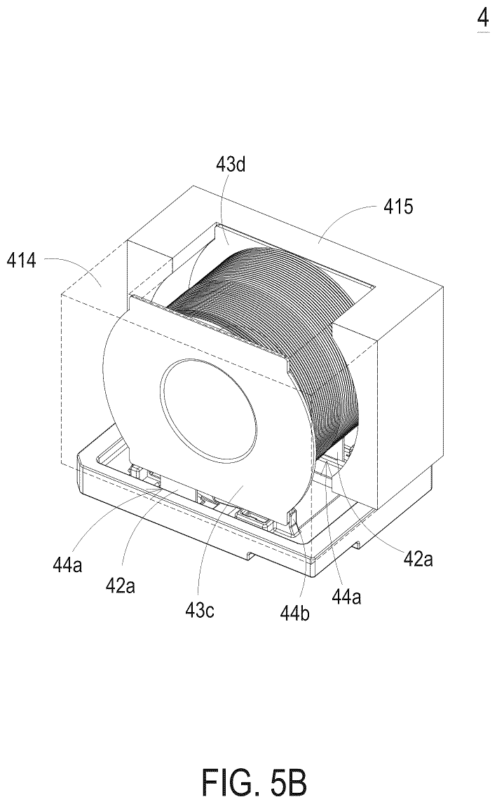

FIG. 5A is an exploded view illustrating a magnetic component according to a fifth embodiment of the present disclosure. FIG. 5B is a schematic perspective view illustrating the magnetic component according to the fifth embodiment of the present disclosure. As shown in FIGS. 5A and 5B, the magnetic component 4 is but not limited to an inductor or a choke. The magnetic component 4 includes a magnetic core 41, a winding 42, a first insulating and thermal-conducting element 43 and a second insulating and thermal-conducting element 44. The magnetic core 41 includes a first magnetic core part 41a and a second magnetic core part 41b. The first magnetic core part 41a and the second magnetic core part 41b are coupled to each other and includes a center leg 411, a first lateral leg 412, a second lateral leg 413, a first magnetic plate 414, a second magnetic plate 415 and an annular space 416. Two ends of the center leg 411 of the magnetic core 41 are respectively connected to the first magnetic plate 414 and the second magnetic plate 415, and the center leg 411 is located between the first lateral leg 412 and the second lateral leg 413. Two ends of each of the first lateral leg 412 and the second lateral leg 413 are respectively connected to the first magnetic plate 414 and the second magnetic plate 415. The first lateral leg 412 and the second lateral leg 413 are disposed on two opposite lateral sides of the first magnetic plate 414 and the second magnetic plate 415. The annular space 416 is collaboratively defined by the center leg 411, the first lateral leg 412 and the second lateral leg 413. In an embodiment, the first magnetic core part 41a and the second magnetic core part 41b are EE type magnetic cores, but is not limited thereto.

In this embodiment, the first insulating and thermal-conducting element 43 is configured as a bobbin and includes a winding tube 43a, a winding area 43b a first flange 43c, a second flange 43d and a passage 43e. The winding area 43b is disposed around the outer periphery of the winding tube 43a, and the first flange 43c and the second flange 43d are connected to and disposed on two ends of the winding tube 43a. The passage 43e penetrates the center of the winding tube 43a. The first insulating and thermal-conducting element 43 is formed in the annular space 416 of the magnetic core 41 by insert molding process. The center leg 411 of the magnetic core 41 is accommodated in the passage 43e of the first insulating and thermal-conducting element 43, and the first insulating and thermal-conducting element 43 encapsulates and is attached and coupled to the outer peripheral surface of the center leg 411. The winding 42 is wound around the winding area 43b of the first insulating and thermal-conducting element 43 and includes two terminal ends 42a. The second insulating and thermal-conducting element 44 has a plate structure and includes two perforations 44a, four convex parts 44b, an outer frame 44c and a hollow portion 44d. The two perforations 44a penetrate the second insulating and thermal-conducting element 44 and are corresponding in position to the two terminal ends 42a. In addition, the two terminal ends 42a of the winding 42 are disposed through the perforations 44a to be served as pins. The outer frame 44c surrounds the hollow portion 44d.

In this embodiment, the first insulating and thermal-conducting element 43 is disposed above the second insulating and thermal-conducting element 44 and is corresponding in position to the hollow portion 44d. The second insulating and thermal-conducting element 44 is formed by insert molding process, and the second insulating and thermal-conducting element 44 encapsulates or is attached and coupled to the bottom surface of the magnetic core 41. The four convex parts 44b of the second insulating and thermal-conducting element 44 are connected to the peripheral edges of the first flange 43c and the second flange 43d of the first insulating and thermal-conducting element 43. In an embodiment, the second insulating and thermal-conducting element 44 and the first insulating and thermal-conducting element 43 are integrally formed in one piece. Portions of the second insulating and thermal-conducting element 44 near the perforations 44a encapsulate and are attached and coupled to parts of the two terminal ends 42a of the winding 42, so that the winding 42 is thermally coupled to the second insulating and thermal-conducting element 44 through the two terminal ends 42a. Consequently, by the arrangement of the first insulating and thermal-conducting element 43 and the second insulating and thermal-conducting element 44, a thermal bus path is formed and the heat generated by the magnetic core 41 and the winding 42 is transferred away through the thermal bus path. At the same time, the two terminal ends 42a of the winding 42 are fixed and served as pins.

In addition, the first insulating and thermal-conducting element 43 is served as a bobbin, and the second insulating and thermal-conducting element 44 is served as a base for the magnetic component 4. Consequently, the thermal conductivity is enhanced, the heat dissipation efficiency is improved, the fixation strength is increased and the volume is reduced, the elements in the magnetic component are integrated, the manufacturing time and cost are reduced, and the waterproof and dustproof effects are achieved.

In an embodiment, the magnetic component 4 further includes a metal plate 44e embedded in the outer frame 44c of the second insulating and thermal-conducting element 44 to increase the temperature uniformity and the equivalent thermal conductivity of the second insulating and thermal-conducting element 44. Consequently, the efficiency of dissipating the heat away from the magnetic component 4 is improved. In some embodiments, the second insulating and thermal-conducting element 44 is served as a circuit board, and the above-mentioned metal plate 44e is not encapsulated by the second insulating and thermal-conducting element 44, but not limited thereto.

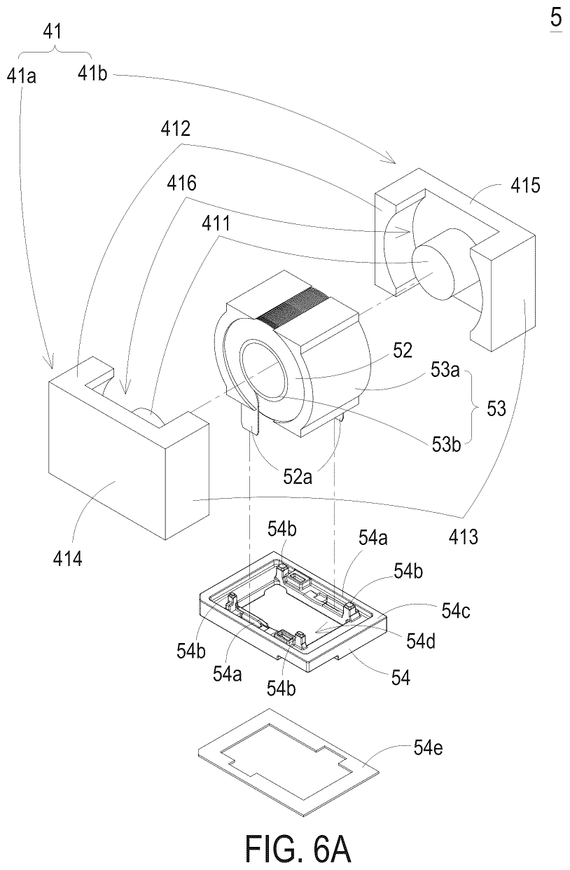

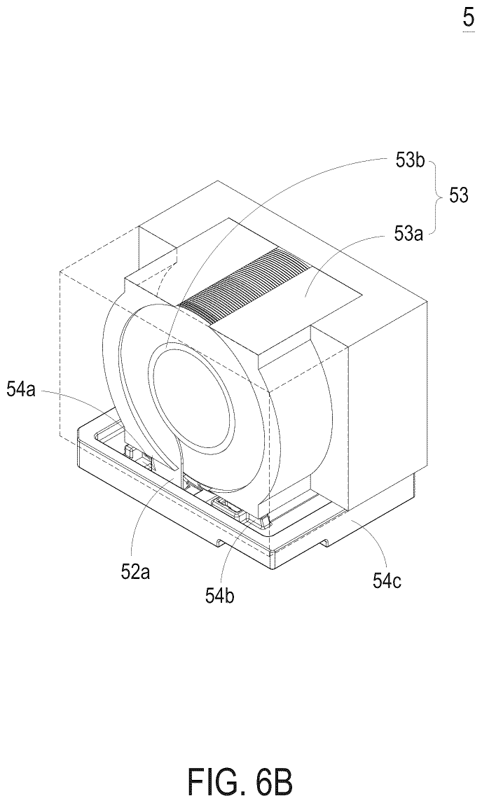

FIG. 6A is an exploded view illustrating a magnetic component according to a sixth embodiment of the present disclosure. FIG. 6B is a schematic perspective view illustrating the magnetic component according to the sixth embodiment of the present disclosure. As shown in FIGS. 6A and 6B, the magnetic component 5 is but no limited to an inductor or a choke. The magnetic component 5 includes a magnetic core 41, a winding 52, a first insulating and thermal-conducting element 53 and a second insulating and thermal-conducting element 54. The structures and functions of the magnetic core 41, the winding 52 and the second insulating and thermal-conducting element 54 are similar to the magnetic core 41, the winding 42 and the second insulating and thermal-conducting element 44 of the fifth embodiment and are not redundantly described hereinafter. In this embodiment, differing from the first insulating and thermal-conducting element 43 of the magnetic component 4 of the fifth embodiment, the first insulating and thermal-conducting element 53 of the magnetic component 5 includes a first insulating and thermal-conducting part 53a and a second insulating and thermal-conducting part 53b. The first insulating and thermal-conducting part 53a has two essentially semi-ring structures, and the two semi-ring structures are symmetrical to an axis of the center leg 411 and formed in the annular space 416 of the magnetic core 41. The first insulating and thermal-conducting part 53a encapsulates and is attached and coupled to the inner peripheral surface of the annular space 416 of the magnetic core 41 and at least portion of the outer peripheral surface of the winding 52. The second insulating and thermal-conducting part 53b has a ring-shaped structure and is sandwiched between the outer peripheral surface of the center leg 411 and the inner peripheral surface of the winding 52. The inner peripheral surface of the second insulating and thermal-conducting part 53b is attached and coupled to the outer peripheral surface of the center leg 411 of the magnetic core 41, and the outer peripheral surface of the second insulating and thermal-conducting part 53b is attached and coupled to the inner peripheral surface of the winding 52. The second insulating and thermal-conducting part 53b is served as a bobbin. The winding 52 is wound around the peripheral edge of the second insulating and thermal-conducting part 53b with the center leg 411 as the axis. The winding 52 includes two terminal ends 52a, and each of the terminal ends 52a penetrates and is positioned in the first insulating and thermal-conducting part 53a. In addition, each of the terminal ends 52a is protruded from the bottom surface of the first insulating and thermal-conducting part 53a to be served as a pin. In other embodiment, the first insulating and thermal-conducting part 53a encapsulates the external peripheral surface of the winding 52 entirely.

In this embodiment, the axis of the center leg 411 is parallel to the second insulating and thermal-conducting element 54. The second insulating and thermal-conducting element 54 has a plate structure and includes two perforations 54a, four convex parts 54b, an outer frame 54c and a hollow portion 54d. The first insulating and thermal-conducting element 53 is disposed above the second insulating and thermal-conducting element 54 and is corresponding in position to the hollow portion 54d. The second insulating and thermal-conducting element 54 is formed by insert molding process and encapsulates or is attached and coupled to the bottom surface of the magnetic core 41. The four convex parts 54b of the second insulating and thermal-conducting element 54 are connected to the peripheral edge of the first insulating and thermal-conducting element 53. In an embodiment, preferably but not exclusively, the second insulating and thermal-conducting element 54 and the first insulating and thermal-conducting element 53 are integrally formed in one piece. Portions of the second insulating and thermal-conducting element 54 near the perforations 54a encapsulate and are attached and coupled to parts of the two terminal ends 52a of the winding 52, so that the winding 52 is thermally coupled to the second insulating and thermal-conducting element 54 through the two terminal ends 52a. Consequently, by the arrangement of the first insulating and thermal-conducting element 53 and the second insulating and thermal-conducting element 54, a thermal bus path is formed and the heat generated by the magnetic core 41 and the winding 52 is dissipated away through the thermal bus path. At the same time, the two terminal ends 52a of the winding 52 are fixed and served as pins. In addition, the second insulating and thermal-conducting part 53b is served as a bobbin, and the second insulating and thermal-conducting element 54 is served as a base for the magnetic component 5. Consequently, the thermal conductivity is enhanced, the heat dissipation efficiency is improved, the fixation strength is increased, the volume is reduced, the elements in the magnetic component are integrated, the manufacturing time and cost are reduced, and the waterproof and dustproof effects are achieved.

In some embodiments, the magnetic component 5 further includes a metal plate 54e embedded in the outer frame 54c of the second insulating and thermal-conducting element 54 to increase the temperature uniformity and the equivalent thermal conductivity of the second insulating and thermal-conducting element 54. Consequently, the efficiency of the magnetic component 5 is improved. In some embodiments, the second insulating and thermal-conducting element 54 is configured as a circuit board, and the above-mentioned metal plate 54e is not encapsulated by the second insulating and thermal-conducting element 54, but not limited thereto.

In some embodiments, the above-mentioned insulating and thermal-conducting elements are made of the bulk molding compound (BMC) having a specific thermal conductivity coefficient. Preferably but not exclusively, the specific thermal conductivity coefficient is ranged between 1.5 W/m·k and 3.0 W/m·k. The above-mentioned insulating and thermal-conducting elements are formed by utilizing the insert molding process with at least parts of the magnetic core and the winding inserted in the bulk molding compound. The material and the forming method of the insulating and thermal-conducting elements are not limited to the above embodiments and can be adjusted according to the practical requirements.

In conclusion, the present disclosure provides a magnetic component that utilizes at least one insulating and thermal-conducting element to at least partially encapsulate or attach and couple to at least one of the magnetic core and the winding. Consequently, a thermal bus path is formed for transferring the heat generated by the magnetic core and/or the winding. Additionally, the insulating and thermal-conducting element is served as a base or a molded component for the magnetic component. Consequently, the thermal conductivity is enhanced, the heat dissipation efficiency is improved, the fixation strength is increased, the volume is reduced, the elements in the magnetic component are integrated, the manufacturing time and cost are reduced, and the waterproof and dustproof effects are achieved. Moreover, the finished product of the present disclosure is directly formed by the material with high thermal conductivity through the molding technique. The dimensional errors caused by manual positioning in conventional methods can be avoided. Besides, the dimensional accuracy can be improved and controlled within plus or minus 0.2 mm, which is unachievable by conventional methods.

While the disclosure has been described in terms of what is presently considered to be the most practical and preferred embodiments, it is to be understood that the disclosure needs not be limited to the disclosed embodiment. A person skilled in the art can clearly understand that the embodiments described in the disclosure can be adjusted. The components in the embodiments can be replaced by equivalent components without deviating from the spirit and scope of the disclosure. The figures may not be drawn in accordance with the aspect ratio. An embodiment not described in the disclosure exists. The specification should be regarded as being illustrative but not restrictive. It is intended to cover various modifications and similar arrangements about conditions, materials, composes of substances, methods or manufacture processes included within the purpose, characteristic, spirit and scope of the appended claims which are to be accorded with the broadest interpretation so as to encompass all such modifications and similar structures. Although the methods disclosed herein have been described with reference to specific operations performed in a specific order, it is understood that these operations can be combined, subdivided, or reordered to form equivalents without deviating from the teachings of the disclosure. Therefore, unless there is specifical indication in the disclosure, the order of operations and the arrangement of groups are not a limitation of the disclosure.

What is claimed is:

1. A magnetic component comprising:
a magnetic core;
at least one winding wound around the magnetic core; and
at least one insulating and thermal-conducting element, at least partially encapsulating or attached and coupled to at least one of the magnetic core and the winding, and served as a thermal bus path for transferring heat generated by the magnetic core or the winding.

2. The magnetic component according to claim 1, wherein the magnetic component is an inductor, a choke or a transformer.

3. The magnetic component according to claim 1, wherein the magnetic core comprises a magnetic ring, a hollow portion, a top surface and a bottom surface, and the hollow portion penetrates the magnetic ring, wherein each of the at least one winding passes through the hollow portion, is wound around the magnetic ring and comprises two terminal ends, each of the terminal ends is protruded from the bottom surface of the magnetic core, the insulating and thermal-conducting element encapsulates or is attached and coupled to the bottom surface of the magnetic core, wherein each of the terminal ends penetrates through and is positioned in the insulating and thermal-conducting element, and each of the terminal ends is protruded from a bottom surface of the insulating and thermal-conducting element to be served as a pin, wherein an axis of the magnetic ring is perpendicular to the insulating and thermal-conducting element.

4. The magnetic component according to claim 3, wherein the magnetic component further comprises a metal plate embedded in the at least one insulating and thermal-conducting element.

5. The magnetic component according to claim 1, wherein the magnetic core comprises a magnetic ring, a hollow portion, a top surface and a bottom surface, and the hollow portion penetrates the magnetic ring, wherein each of the at least one winding passes through the hollow portion, is wound around the magnetic ring and comprises two terminal ends, each of the terminal ends is protruded from the bottom surface of the magnetic core, wherein the at least one insulating and thermal-conducting element comprises a first insulating and thermal-conducting element and a second insulating and thermal-conducting element, the first insulating and thermal-conducting element at least partially encapsulates or is attached and coupled to the bottom surface of the magnetic core and portion of the winding, the second insulating and thermal-conducting element at least partially encapsulates or is attached and coupled to the top surface of the magnetic core and portion of the winding, each of the terminal ends penetrates through and is positioned in the first insulating and thermal-conducting element, and each of the terminal ends is protruded from a bottom surface of the first insulating and thermal-conducting element to be served as a pin, wherein an axis of the magnetic ring is perpendicular to the first insulating and thermal-conducting element.

6. The magnetic component according to claim 5, wherein the magnetic component further comprises a metal plate embedded in the at least one insulating and thermal-conducting element.

7. The magnetic component according to claim 1, wherein the at least one winding comprises a first winding and a second winding, the magnetic core comprises a first magnetic core part and a second magnetic core part, the first magnetic core part and the second magnetic core part are coupled to each other and includes a magnetic frame, a hollow portion, a top surface and a bottom surface, and the hollow portion penetrates the magnetic frame, wherein each of the at least one winding passes through the hollow portion, is wound around the magnetic frame, and comprises two terminal ends, each of the terminal ends are protruded from the bottom surface of the magnetic core, wherein the at least one insulating and thermal-conducting element comprises a first insulating and thermal-conducting element and a second insulating and thermal-conducting element, wherein the first insulating and thermal-conducting element at least partially encapsulates the at least one winding, the second insulating and thermal-conducting element is disposed in the hollow portion, attached and coupled to the bottom surface of the magnetic core, and located between the first winding and the second winding, wherein a first end of the second insulating and thermal-conducting element is coupled to the first insulating and thermal-conducting element, wherein each of the terminal ends is protruded from a bottom surface of the first insulating and thermal-conducting element to be served as a pin.

8. The magnetic component according to claim 7, wherein the magnetic component comprises at least one metal plate or a magnetic plate, and the at least one metal plate or the magnetic plate are embedded in the second insulating and thermal-conducting element, wherein the at least one winding comprises at least one first winding and at least one second winding.

9. The magnetic component according to claim 7, wherein the insulating and thermal-conducting element further comprises a third insulating and thermal-conducting element disposed on the top surface of the magnetic core and coupled to a second end of the second insulating and thermal-conducting element.

10. The magnetic component according to claim 9, wherein the third insulating and thermal-conducting element at least partially encapsulates or is attached and coupled to the at least one winding.

11. The magnetic component according to claim 1, wherein the magnetic component further comprises a bobbin, the bobbin comprises at least one winding tube and at least one passage, each of the at least one passage penetrates the corresponding one of the at least one winding tube, wherein the at least one winding is wound around a winding area of the at least one winding tube, the magnetic core partially passes through the at least one passage of the bobbin, and the magnetic core is partially exposed out from the bobbin and comprises a top surface and a bottom surface, wherein each of the at least one winding comprises two terminal ends, each of the terminal ends is protruded from the bottom surface of the magnetic core, wherein the insulating and thermal-conducting element at least partially encapsulates or is attached and coupled to the bottom surface of the magnetic core, each of the terminal ends penetrates through and is positioned in the insulating and thermal-conducting element, and each of the terminal ends is protruded from a bottom surface of the insulating and thermal-conducting element to be served as a pin.

12. The magnetic component according to claim 1, wherein the magnetic core comprises a first magnetic core part and a second magnetic core part, the first magnetic core part and the second magnetic core part are coupled to each other and comprises a center leg, a first lateral leg, a second lateral leg, a first magnetic plate, a second magnetic plate and an annular space, wherein two ends of the center leg are respectively connected to the first magnetic plate and the second magnetic plate, two ends of the first lateral leg are respectively connected to the first magnetic plate and the second magnetic plate, two ends of the second lateral leg are respectively connected to the first magnetic plate and the second magnetic plate, the first magnetic plate is parallel to the second magnetic plate, the center leg is positioned between the first lateral leg and the second lateral leg, the annular space is collaboratively defined by the center leg, the first lateral leg and the second lateral leg, wherein the at least one insulating and thermal-conducting element comprises a first insulating and thermal-conducting element, the first insulating and thermal-conducting element is served as a bobbin and disposed in the annular space, and an inner peripheral surface of the first insulating and thermal-conducting element encapsulates and is attached and coupled to an outer peripheral surface of the center leg of the magnetic core, wherein the at least one winding is wound around the winding area of the first insulating and thermal-conducting element.

13. The magnetic component according to claim 12, wherein the at least one insulating and thermal-conducting element further comprises a second insulating and thermal-conducting element, the second insulating and thermal-conducting element encapsulates or is attached and coupled to a bottom surface of the magnetic core, wherein each of the at least one winding comprises two terminal ends, each of the terminal ends penetrates and is positioned in the second insulating and thermal-conducting element, and each of the terminal ends is protruded from a bottom surface of the second insulating and thermal-conducting element to be served as a pin, wherein an axis of the center leg is parallel to the second insulating and thermal-conducting element.

14. The magnetic component according to claim 13, wherein the first insulating and thermal-conducting element and the second insulating and thermal-conducting element are integrally formed in one piece.

15. The magnetic component according to claim 1, wherein the magnetic core comprises a first magnetic core part and a second magnetic core part, the first magnetic core part and the second magnetic core part are coupled to each other and comprises a center leg, a first lateral leg, a second lateral leg, a first magnetic plate, a second magnetic plate and an annular space, wherein two ends of the center leg are respectively connected to the first magnetic plate and the second magnetic plate, two ends of the first lateral leg are respectively connected to the first magnetic plate and the second magnetic plate, two ends of the second lateral leg are respectively connected to the first magnetic plate and the second magnetic plate, the first magnetic plate is parallel to the second magnetic plate, the center leg is positioned between the first lateral leg and the second lateral leg, the annular space is collaboratively defined by the center leg, the first lateral leg and the second lateral leg, wherein the at least one winding is wound around the center leg, wherein the at least one insulating and thermal-conducting element comprises a first insulating and thermal-conducting element, the first insulating and thermal-conducting element comprises a first insulating and thermal-conducting part and a second insulating and thermal-conducting part, the first insulating and thermal-conducting part is formed in the annular space and attached to an inner surface of the annular space and at least portion of an outer peripheral surface of the at least one winding, the second insulating and thermal-conducting part is disposed in the annular space and attached to an inner peripheral surface of the at least one winding and an outer peripheral surface of the center leg of the magnetic core.

16. The magnetic component according to claim 15, wherein the at least one insulating and thermal-conducting element further comprises a second insulating and thermal-conducting element, the second insulating and thermal-conducting element encapsulates or is attached and coupled to a bottom surface of the magnetic core, wherein each of the at least one winding comprises two terminal ends, each of the terminal ends penetrates and is positioned in the second insulating and thermal-conducting element, and each of the terminal ends is protruded from a bottom surface of the second insulating and thermal-conducting element to be served as a pin, wherein an axis of the center leg is parallel to the second insulating and thermal-conducting element.

17. The magnetic component according to claim 16, wherein the first insulating and thermal-conducting element and the second insulating and thermal-conducting element are integrally formed in one piece.

18. The magnetic component according to claim 1, where each of the at least one insulating and thermal-conducting element has a specific thermal conductivity coefficient ranged between 1.5 W/m·k and 3.2 W/m·k.
